(19) United States
(12) Patent Application Publication
(10) Pub. No.: US 2006/0081739 A1
(43) Pub. Date: Apr. 20, 2006

(54) Self locking telescoping jack

(76) Inventor: Jason Meissner, Cranfills Gap, TX (US)

Correspondence Address: Robert Greeson, 900 Washington Avenue, 7th Floor, P.O. Box 1470, Waco, TX, 77603-1470, US

(21) Appl. No.: 10/965,363

(22) Filed: Oct. 14, 2004

(51) Int. Cl. F16M 11/00

(52) U.S. Cl. 248/161

(57) ABSTRACT

A self locking telescoping jack device. This device is characterized by a standard jack contained within, and affixed to, an inner tube. The inner tube fits within and slideably engages a concentric outer tube. The inner tube and outer tube are further engaged by a peg-elongate aperture configuration, where a peg extending from the inner tube moves along the length of the elongate tube. Receiving slots are positioned at either end of the aperture to lock the jack into position. During operation, the inner tube (and jack contained therein) actuate within the outer tube between an extended and retracted position. The jack easily moves between either position by lifting or lowering the peg to disengage from the receiving slot.

### BACKGROUND OF THE INVENTION

1. Field of the Invention

The present invention generally relates to a jack for moveably supporting a load, such as a trailer. More specifically, the present invention relates to a jack that telescopes between an extended and retracted position and self-locks in either position.

2. Background Information

The use of jacks, and specifically those used in combination with trailers, is known in the art. More specifically, jacks heretofore devised and utilized are known to consist basically of familiar, expected and obvious structural configurations, notwithstanding the myriad of designs encompassed by the crowded prior art which have been developed for the fulfillment of countless objectives and requirements.

Known documents include: U.S. Pat. Nos. 5,184,839, 4,842,252, 4,078,774, and 4,053,174. While these devices may fulfill their respective, particularly claimed objectives and requirements, the aforementioned documents do not disclose a telescoping self locking jack such as Applicant's present invention.

Trailer jacks are a necessity in many industries, including the agriculture, commercial and recreational industries. Jacks are needed to raise and lower trailer with respect to their towing counterparts. Further, these devices needed to offer support of a trailer load and provide lateral stability to a trailer.

There are two predominating types of trailer jacks; the swivel jacks and hydraulic jacks. Swivel jacks operate by cranking a handle to turn a screw which raises and lowers the jack. Hydraulic jacks use hydraulic pressure to raise and lower and may be either manually operated or motorized.

Swivel jacks are cumbersome to use and creates multiple difficulties. These difficulties are several fold. One difficulty is sufficient available space for a crank handle to rotate in oftentimes cramped conditions due to the surrounding components of the trailer which obstruct rotational motion. Another problem is speed. Raising or lowering the trailer jack takes many rotations, each taking time, particularly if obstructions are present. As a consequence of time constraints or user fatigue, swivel jacks may not be raised or lowered to their proper level resulting in potential damage to the jack, hitch, trailer, or towing vehicle resulting in financial loss and possible injuries. Over time, the master screw which holds the weight of the trailer may succumb to metal fatigue. Since there may be substantial forces on the threads of this master screw they may strip over time. This metal fatigue may or may not be apparent, even if the screw is exposed (a design which subjects the screw to a greater degree of potential damage by natural forces or collisions and other contact with the screw). A failure of the screw could result in personal and/or property damage due to sudden and catastrophic drops.

Hydraulic jacks have advantages over traditional swivel jacks, but still have disadvantages as compared to the present invention. Hydraulic jacks which are manually operated will still require a lever which must be rotated or “pumped” to create the necessary hydraulic pressure to raise the trailer. As with swivel jacks physical impediments may exist making these motions difficult and as with swivel jacks the proper position may not be achieved by the operator with potential consequential damage to the jack, hitch, trailer, or towing vehicle. Motorized hydraulic jacks eliminate the problem of manual operation, however requires a power source to operate creating a new inconvenience and expense. Hydraulic jacks, particularly power jacks, are more expensive than their swivel counterparts. By the very nature of hauling these jacks spend all or a great deal of their time outdoors. As such, these jacks are susceptible to vandalism, theft, and storm damage with the consequence of a high replacement cost. As with swivel jacks there is the potential for failure of the jack if there is a loss of hydraulic pressure. As the components of these types of jacks are all internal it may not be evident to the user of such a device that the jack is damaged or in need of replacement. The failure of a hydraulic jack during operation could cause both property and personal injuries.

In view of the limitations associated with known jacks, there is a great need for a jack that is affordable, has a very small footprint, and can easily be moved between a support position and a transport position. Applicant's invention, through a novel combination of component pieces, provides such a jack device. The present invention is primarily beneficial in that it allows a user to quickly and easily move a jack between an upper and lower position. In its upper position, the jack is sufficiently above the ground so that it may travel without “bottoming out” over any bumps or hills. In its lower position, the jack is sufficiently close to the ground so that it may be extended to provide appropriate lateral and vertical support for a trailer load. Moreover, the device allows the jack to easily engage and remain “locked” in each respective position; yet easily be disengaged and moved to another position. Finally, by virtue of a housing combination, the jack remains protected from passing objects during use or transport.

### SUMMARY OF THE INVENTION

The general purpose of the present invention, which will be described subsequently in greater detail, is to provide a new self locking telescoping jack device which has many of the advantages of the jack devices known in the art and many novel features that result in a new jack device which is not anticipated, rendered obvious, suggested, or even implied by any of the known devices, either alone or in any combination thereof.

It is an object of the present invention to provide a self locking telescoping jack device that remains vertically aligned during operation and non operation.

It is another object of the present invention to provide a self locking telescoping jack device where a jack may quickly and easily be moved between a top and a bottom position.

It is another object of the present invention to provide a self locking telescoping jack device where a jack may remain in a support position while in transport.

It is another object of the present invention to provide a self locking telescoping jack device where a jack actuates between an extended and a retracted position.

It is another object of the present invention to provide a self locking telescoping jack device where a jack is protected by a housing.

It is another object of the present invention to provide a self locking telescoping jack device that does not have to rotate about a trailer juxtaposition.

It is another object of the present invention to provide a self locking telescoping jack device that does not have the space constraints of manual swivel and hydraulic jacks.

It is another object of the present invention to provide a self locking telescoping jack device that is affordable.

In view of the foregoing and other related objectives, the present invention provides a self locking telescoping jack device. Generally, the present device is beneficial in that it provides a means for a standard jack to remain vertically aligned while moving between a top and bottom position, all the while remaining engaged with a trailer-type vehicle. In its top, or extended position, the jack remains elevated and vertically aligned with respect to the trailer. This arrangement is advantageous while the associated vehicle is in transit. In its bottom, or retracted position, the jack remains lowered and vertically aligned with respect to the trailer. This arrangement allows the jack to be further extended to support the trailer load.

The novel configuration of the present device is thought to provide several benefits. For instance, the present device is thought to replace those jacks that typically rotate about a trailer juxtaposition between a vertical and horizontal configuration. After all, there are several embodiments of trailers that make it difficult to position a jack where it may both adequately support the trailer load (when used) and rotate to rest along the length of the trailer (when not used). Such is most often seen where the tongue of the trailer is particularly short or steeply slanted. Further, and perhaps most importantly, the device of the present device makes it easy to ready a jack for transit. With the present device, a user may simply lift the jack to the extended position. At this point, there is sufficient clearance between the bottom of the jack and the ground, that one need not worry about the jack “bottoming out.” Simply being able to lift the jack into a transit position is much easer and faster than the standard method, which typically involves manually turning a crank to retract the jack.

The present device is characterized by a standard jack contained within an inner tube. The inner tube and the jack are mated with one another (typically by a straightforward welding method) so that each will not move with respect to the other. Further, the inner tube slideably engages with an outer tube and moves along the length of the outer tube between an extended and retracted position. As retracted, the inner tube is substantially contained within the outer tube; as extended, the inner tube substantially protrudes from the outer tube. The inner tube and outer tube are further engaged with one another. That is, the inner tube contains a peg extending from its outer surface into an elongate aperture contained within the outer surface of the outer tube. This elongate aperture of the outer tube extends lengthwise along the outer tube and typically has some associated curvature. By virtue of this curvature, as the inner tube slides within the outer tube between an extended and retracted position, and the peg follows along the elongate aperture, the inner tube rotates with respect to the outer tube.

The relative rotation between each tube helps establish the self-locking nature of the present device. That is, this rotation helps the peg of the inner tube fit into a receiving slot located at either end of the elongate aperture. Each receiving slot is of a general “J-shape” and has a notch that receives and holds the peg. As the peg fits within these notches, the device is essentially locked in either a fully extended or a fully retracted position. That is, as the peg fits within the top receiving slot, the inner tube (and jack contained therein) are maintained in the extended position where the inner tube and the jack rest above the outer tube. This configuration is ideal when the associated trailer is in transit. When the peg fits within the lower receiving slot, the inner tube (and jack contained therein) are maintained in a retracted position where the tube and jack are substantially contained in the outer tube. This configuration presents the jack in a lowered position whereby it may further be extended to the ground to support the trailer load.

### BRIEF DESCRIPTION OF THE DRAWINGS

FIG. 1 is a perspective view of the telescoping self locking trailer jack of the present invention in a retracted position.

FIG. 2 is a perspective view of the telescoping self locking trailer jack of the present invention in an extended position.

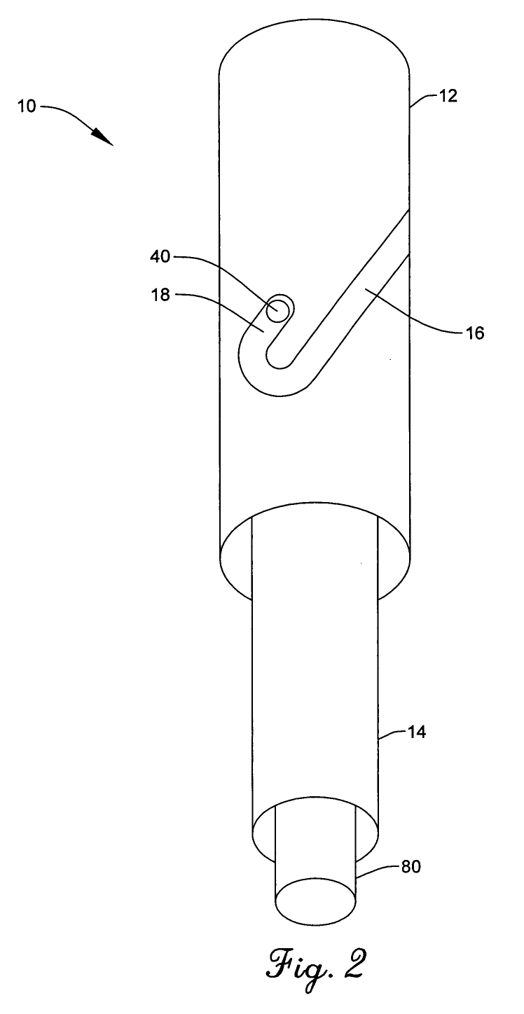

### DETAILED DESCRIPTION OF THE PREFERRED EMBODIMENT

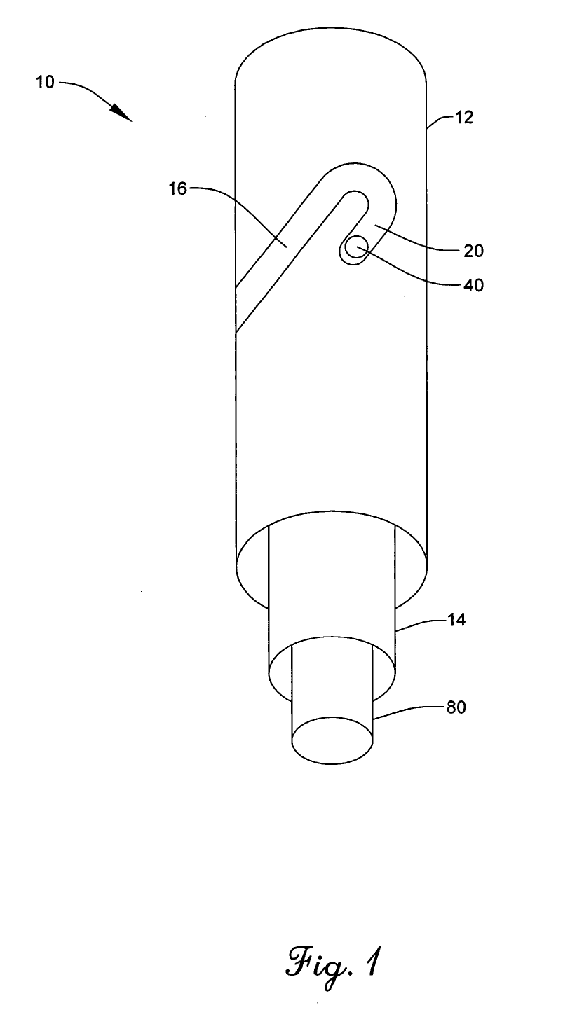

Referring to FIG. 1, the self locking telescoping device of the present invention is generally designated by the reference numeral 10. In the preferred embodiment, device 10 is comprised of some metal or metal alloy. Such is the case in that metal or metal alloy material provides the strength required to support the loads associated with use of device 10.

Device 10 is primarily characterized by a pair of concentric tubes, outer tube 12 and an inner tube 14. In the preferred embodiment, outer tube 12 is vertically fixed to some towed device, such as a trailer. Such an arrangement is preferred as device 10 is thought to be most useful in the case where there is not sufficient space for a jack to extend lengthwise along the body of the trailer. In such case, device 10 allows a jack 80 to move vertically between a top and bottom position thereby not taking any horizontal space along the trailer. However, one could easily envision other useful embodiments where outer tube 12 is moveably joined to the trailer.

Inner tube 14 contains, and is mated with, a standard jack 80 as known in the art. Standard jack 80 may be any one of several kinds of jacks as known in the art; however, in the preferred embodiment, jack 80 is some “swivel” or “crank” jack whereby the jack is actuated between an extended and retracted position by the turn of a crank or swivel. Further, it is important that inner tube 14 and jack 80 be mated with one another in such fashion so that each will not move with respect to the other when device 10 and jack 80 are supporting a load.

Outer tube 12 and inner tube 14 are slideably engaged with one another where inner tube 14 (and jack 80 contained therein) fits within, and slides along, the length of outer tube 12. The relative motion of outer tube 12 and inner tube 14 establishes the telescoping property of device 10. More specifically, inner tube 14 actuates between an extended position and a retracted position within outer tube 12. When device 10 is in a retracted position, substantially all of inner tube 14 is contained within outer tube 12. However, when device 10 is in an extended position, substantially all of inner tube 14 protrudes from outer tube 12.

Inner tube 14 and outer tube 12 are further engaged with one another by a peg-aperture combination. Peg 40 extends from the outer surface of tube 14 and is received by an elongate aperture 16 contained within the outer surface of outer tube 12. As each tube moves between an extended and retracted position, peg 40 moves along the length of elongate aperture 16. In the preferred embodiment, each elongate aperture 16 extends lengthwise along the outer surface of outer tube 12. and has an associated curvature, so that as inner tube 14 slides within outer tube 12 between said extended and said retracted position, and peg 40 moves along the length within elongate aperture 16, inner tube 14 rotates with respect to outer tube 12.

Again referring to FIG. 1, each elongate aperture 16 has a top receiving slot 18 and a bottom receiving slot 20. The configuration of each receiving slot works in conjunction with the lengthwise curvature of elongate aperture 16 to help peg 40 naturally slide into either the top receiving slot 18 and the bottom receiving slot 20 upon reaching a fully retracted or fully extended position, respectively.

Both top receiving slot 18 and bottom receiving slot 20 extend from each elongate aperture 16 so as to naturally receive peg 40. Each receiving slot is of a general “J-shape” and contains a notch that peg 40 fits within. When peg 40 is engaged in top slot 18 or bottom slot 20, device 10 essentially becomes “locked” in a fully extended or fully retracted position, respectively. In easy fashion, someone can manually remove device 10 from one of the locked position when the device is not under some load. By simply lifting or lowering outer tube 12 from its respective receiving slot, device 10 may freely move between the extended or retracted position. Put simply, slot 18 and slot 20 are configured to receive and securely hold peg 40 in a fixed position when the device is being used or is under some load; however, each receiving slot is further configured to allow peg 40 to easily disengage from each receiving slot when device 10 is not supporting a load. As such, a primary advantage of device 10 is the ease with which it move between an extended and retracted position.

As described above, device 10 serves several functions. Device 10, by virtue of the housing formed by its concentric tubes, outer tube 12 and inner tube 14, protects jack 80. Also, device 10 provides for a quick and effortless way to lower a jack to a position where it may support a load, and raise the jack to a position where it trailer can be moved without bending the jack. Finally, because device 10 is typically vertically arranged, it allows jack 80 secure to trailers where horizontally moving jacks could not.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

1. A device for raising a load carrying structure, comprising:
an outer member having a proximal end and a distal end, said outer member is being configured to engage with said load carrying structure at said proximal end, said outer member having a substantially longitudinal aperture with a first receiving slot located substantially near said proximal end and a second receiving slot located substantially near said distal end, said second receiving slot being configured substantially in a “J” shape, said first receiving slot being configured substantially in an upside down “J” shape;
an inner member, said inner member being telescopically engageable with said outer member via a peg member extending from said inner member and freely traveling along the length of said substantially longitudinal aperture in said outer member until said peg member is engaged by one of said receiving slots, said inner member being configured for actuation between an extended position, where said peg member is engaged by said second receiving slot and substantially all of said inner member telescopically protrudes from said outer member, and a retracted position, where said peg member is engaged by said first receiving slot and substantially all of said inner member is contained within said outer member, said second receiving slot being configured to engage and hold said peg in a fixed position when said device is bearing a load via said load carrying structure, said first receiving slot being configured to allow easy disengagement of said peg for retraction and stowing of said device on said load carrying structure when said device is not bearing a load; and
a jacking mechanism, said jacking mechanism being telescopically contained within said inner member and mated with said inner member such that said jacking mechanism may be telescopically extended in order to raise said load carrying structure.

2-3. (canceled)
